(19) United States
(12) Patent Application Publication
(10) Pub. No.: US 2014/0122370 A1
(43) Pub. Date: May 1, 2014

(54) SYSTEMS AND METHODS FOR MODEL SELECTION

(71) Applicant: HEWLETT-PACKARD DEVELOPMENT COMPAN, Houston, TX (US)

(72) Inventors: Zainab JAMAL, Palo Alto, CA (US); Filippo BALESTRIERI, Mountain View, CA (US)

(73) Assignee: HEWLETT-PACKARD DEVELOPMENT COMPANY, L.P., Houston, TX (US)

(21) Appl. No.: 13/664,011

(22) Filed: Oct. 30, 2012

(51) Int. Cl. G06Q 10/00

(52) U.S. Cl. 705/348

(57) ABSTRACT

A non-transitory, computer-readable storage medium contains software that, when executed by a processor, causes the processor to perform various operations such as to receive transactional data, industry-specific data, output requirements, and instructions to run specific data analysis models and tests. The software may also cause the processor to identify, based on the industry-specific data and the output requirements, a set of candidate models and to assess the performance of each candidate model based on the transactional data to select a final model and to perform the selected final model on the transactional data to generate processed data.

### BACKGROUND

Many decisions (e.g., business decisions) are complex and thus difficult to make. For example, accurately forecasting future demand for a business's products enables planning to occur for ordering raw materials and components used to make the products. Factors that may affect such demand forecasting include the general state of the economy, seasonal variations, competitive factors, etc.

### BRIEF DESCRIPTION OF THE DRAWINGS

For a detailed description of various illustrative implementations, reference will now be made to the accompanying drawings in which:

FIG. 1 shows a system in accordance with an example;

FIG. 2 shows another example of a system;

FIG. 3 illustrates the operation of the system in accordance with an example;

FIG. 4 shows an example of the operation of an input collection engine;

FIG. 5 shows an example of the operation of a candidate model selection engine; and

FIG. 6 shows an example of the operation of a final model selection engine.

### DETAILED DESCRIPTION

The implementations described herein are directed to a semi-automatic system that permits a user to derive specific information from a set of transactional and industry-specific data. The information is obtained from a process of selection/generation of suitable data analysis models. A user is afforded insight to how the system functions and can control operation of the system during the model selection process, as well as being provided with results from operation of the system (e.g., an appropriate model).

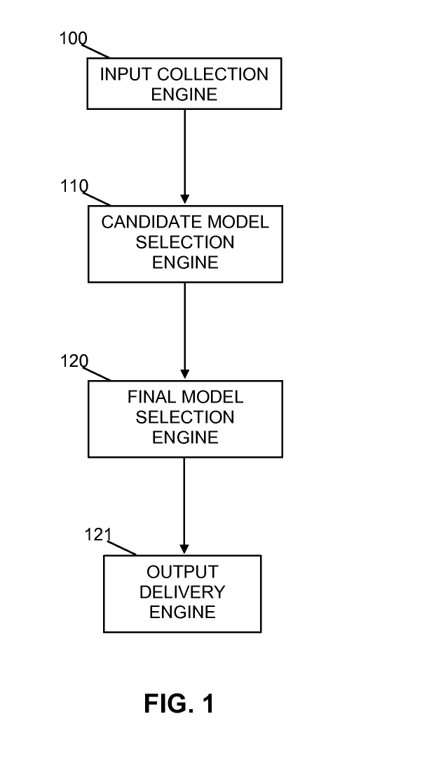

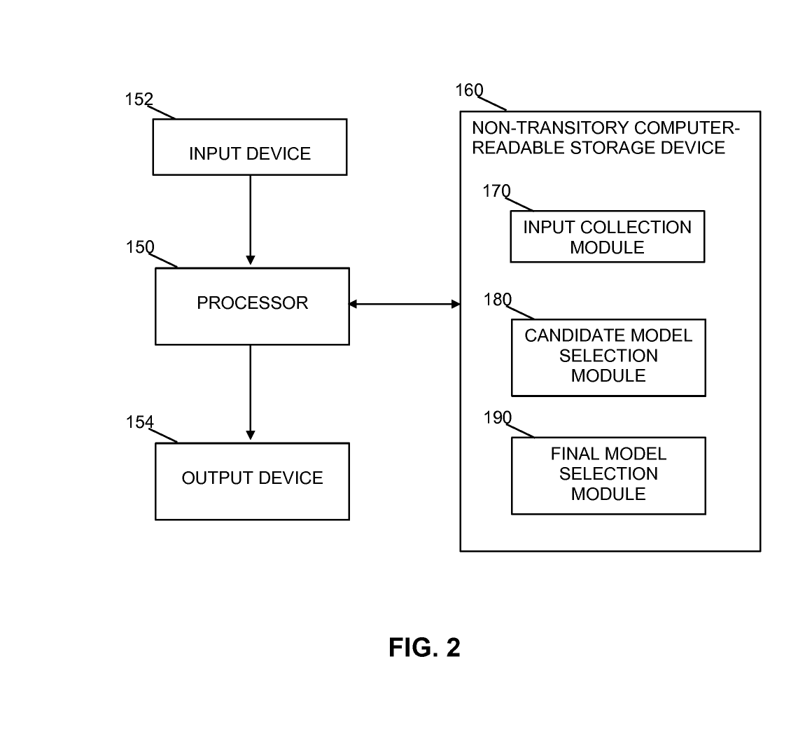

FIG. 1 shows an illustrative implementation of a system including an input collection engine 100, a candidate model selection engine 110, a final model selection engine 120, and an output delivery engine 121. FIG. 2 shows one suitable example of the system in which a processor 150 is coupled to a non-transitory storage device 160, as well as to an input device 152 (e.g., a keyboard, mouse, trackpad, etc.) and to an output device 154 (e.g., a display). The non-transitory storage device 160 may be implemented as volatile storage (e.g., random access memory), non-volatile storage (e.g., hard disk drive, optical storage, solid-state storage, etc.) or combinations of various types of volatile and/or non-volatile storage.

The non-transitory storage device 160 is shown in FIG. 2 to include a software module that corresponds functionally to each of the engines of FIG. 1. The software modules include an input collection module 170, a candidate model selection module 180, and a final model selection module 190. Each engine of FIG. 1 may be implemented as the processor 150 executing the corresponding software module of FIG. 2.

The distinction among the various engines 100-120 and among the software modules 170-190 is made herein for ease of explanation. In some implementations, however, the functionality of two or more of the engines/modules may be combined together into a single engine/module. Further, the functionality described herein as being attributed to each engine 100-120 is applicable to the software module corresponding to each such engine, and the functionality described herein as being performed by a given module is applicable as well as to the corresponding engine.

Overall Operation

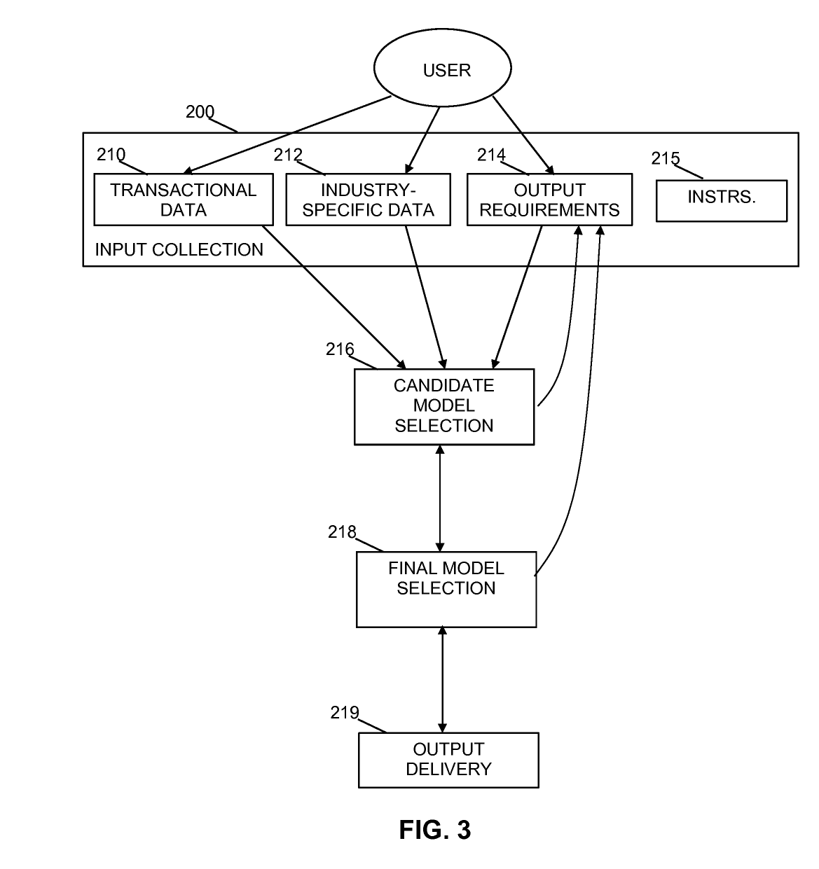

FIG. 3 illustrates an example of the overall operation of the system. With reference to FIGS. 1-3, during the input collection process 200, a user interacts with the input collection engine 100 of the system (e.g., via input device 152 and output device 154) to cause, for example, transactional data 210, industry-specific data 212, and output requirements 214 to be input to the system, as well as instructions to run specific models and instructions to run specific tests. Based on the industry-specific data 212 and output requirements 214, the candidate model selection process 216 uses the candidate model selection engine 110 to select one or more candidate models to be further evaluated during the final model selection process 218 using the final model selection engine 120. The candidate model selection engine 110 may contain a library of candidate models. Each candidate model may be represented in the library as a set of instructions (codes) to process the data. Additionally, the candidate model selection engine 110 also may contain a library of tests. Each test is represented as a set of instructions (codes) to process the data. The selection process performed by the candidate model selection engine 110 is the result of a multi-step process, where the models in the library are evaluated in terms of rules based on industry specific data and output requirements. The models that satisfy the rules then are selected.

The final model selection engine 120 narrows down the list of candidate models by evaluating how well each candidate model performs given the transactional data 210 and the user-provided output requirements. Via the output delivery engine 121, the final model is provided to the user who can select that model for future use or reject the model, change one or more of the transactional data 210, industry-specific data 212, and output requirements 214, add more models and tests, and force the system to re-evaluate to generate another proposed model.

The various processes described herein need not be performed strictly sequentially. For example, the final model selection process 218 may cause control to loop back to the candidate model selection process 216 or prompt the user for additional input in the input collection process 200. Given its dynamic nature, the system allows for a continuous verification and updating of the selections made in previous processes. For example, during the final model selection process 218, the system may automatically detect that an outcome of the analysis does not satisfy one or more of the output requirements 214 provided by the user. This might be because, for example, new transactional or industry-specific data 210, 212 was entered since the output requirements 214 were initially set. In that case, the system will re-perform the candidate model selection process 216, and determine if a different candidate model would result in a better performance. Alternatively, the input collection engine 100 will request the user to enter additional transaction data 210 and/or industry-specific data 212 or to update the output requirements 214.

The output delivery process 219 provides, for example, a graphical user interface to present to the user the results of the model selection process. The presentation may be in the form of a list of the candidate model selection options that were analyzed by the final model selection engine process 218, as well as information regarding the results of the various tests that were performed.

Input

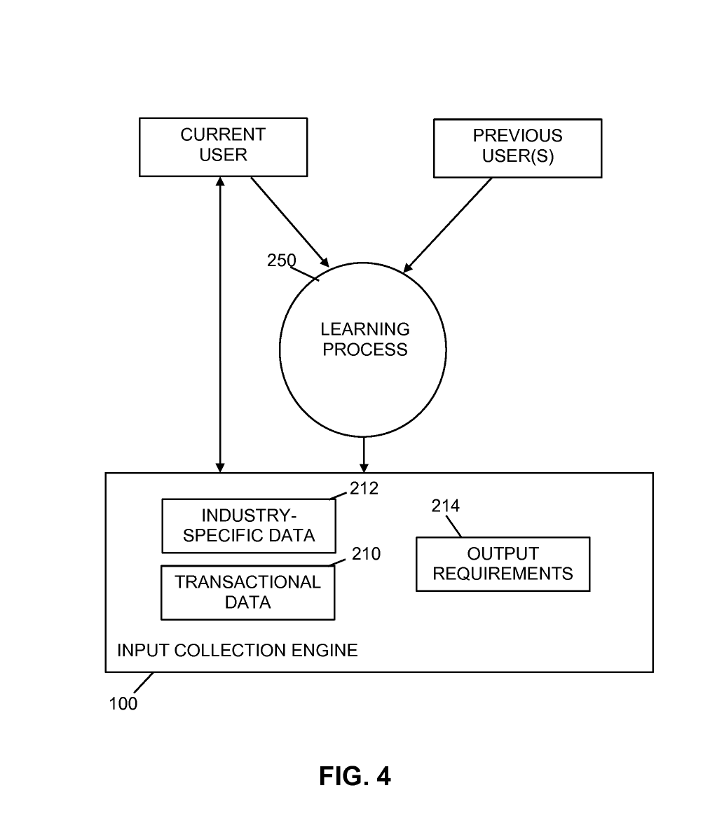

Referring to FIGS. 3 and 4 and as noted above, the user provides, or causes to be provided, transactional data 210, industry-specific data 212 and output requirements 214. The input collection process 200 (e.g., engine 100) may also receive instructions 215 to run specific data analysis models and tests as explained below with regard to the final model selection engine 120. The user also may add models and tests to pre-existing libraries such as adding instructions to run specific models and tests given a dataset. Some or all of the user-provided data 210, 212 and output requirements 214 may be in structured or unstructured form.

Transactional data 210 may include information regarding individual customer transactions. Examples include products sold, prices, quantity, dates of sale, etc. Industry-specific data 212 refers to market structure and industry relevant information that affects the candidate model selection process 216, such as the number of brands in the market, the price points of different brands, and market share of the different brands—across regions and time. Industry-specific data 212 also may include market research reports with unstructured information about the major factors identified as influential in a purchase decision in this situation. A report made of text, figures and tables may be analyzed using text analysis to extract the main concepts of interest like market share of brands, number of brands in the market, annual unit sales, annual revenues, growth rates of unit sales, growth rate of revenues (last 5 years), number of customers, growth rate of customers over time (last 5 years), number of repeat versus new customers, customer segmentation dimensions, brand tiers and who are the cohorts in each tier.

The output requirements 214 may include a description of the analysis requested by the user. The output requirements may include the outcome variable to be estimated. For example, a user may want an estimate of the price elasticity of his own brand A (“own price elasticity”). By way of another example, the user may want to estimate the purchase probability of a customer for another brand B. In another example, the user may want an estimate of the churn risk score of all customers over the next 365 days. The output requirements may also include the accuracy levels with which the outcome variables are to be estimated. An example of an accuracy level might be specified as 95% accuracy or a 5 percent statistical significance level. In another example, the estimated value might be desired to be within 2 standard deviations of the actual values in holdout tests. The output requirements may also include other performance level variables. For example, the model might be required to compute the scores for 1 million customers in less than 5 minutes.

Through the analysis of the industry-specific data, the candidate model selection engine 110 may inform the process about the market structure and industry in which the transactional data 210 is being analyzed and may create a set of selection criteria to be used in the subsequent parts of the process. The candidate model selection engine 110 uses information about the market structure such as there are, for example, two brands in the market to decide the set of variables to be included in a demand function formulation to estimate the price elasticity of the user's own brand A. Further, the candidate model selection engine 110 uses the information that, for example, brands A and B are consumer packaged goods to decide the functional form of the demand function formulation that would be relevant for this type of industries. The candidate model selection engine 110 may use a set of rules to narrow down the model specification. Such rules are identified by the input collecting engine based on previously performed analyses and may include formulae and the variables relevant to such formulae.

User input of the transactional data 210, industry-specific data 212 and output requirements 214, as well as updated or new models and tests may be obtained in several ways. For instance, a user may provide information 252 via input device 152 in a suitable manner (e.g., a structured file or completion of an electronic form), or the input collection engine 100 may explicitly request 254 from the user information that will help it to identify the market structure and industry or fill any identified data gaps.

Alternatively or additionally, the input collection engine 100 may implement a learning process 250 to obtain industry-specific data 212 based on previous uses of the system. For example, if at least a threshold number (e.g., 3) of previous users have entered new industry-specific data 212 via the input collection engine 100 that turned out to be relevant in the candidate model selection process, then, the input collection engine learns and solicits that same type of industry-specific data automatically from a user who uses the system in the future.

Candidate Model Selection

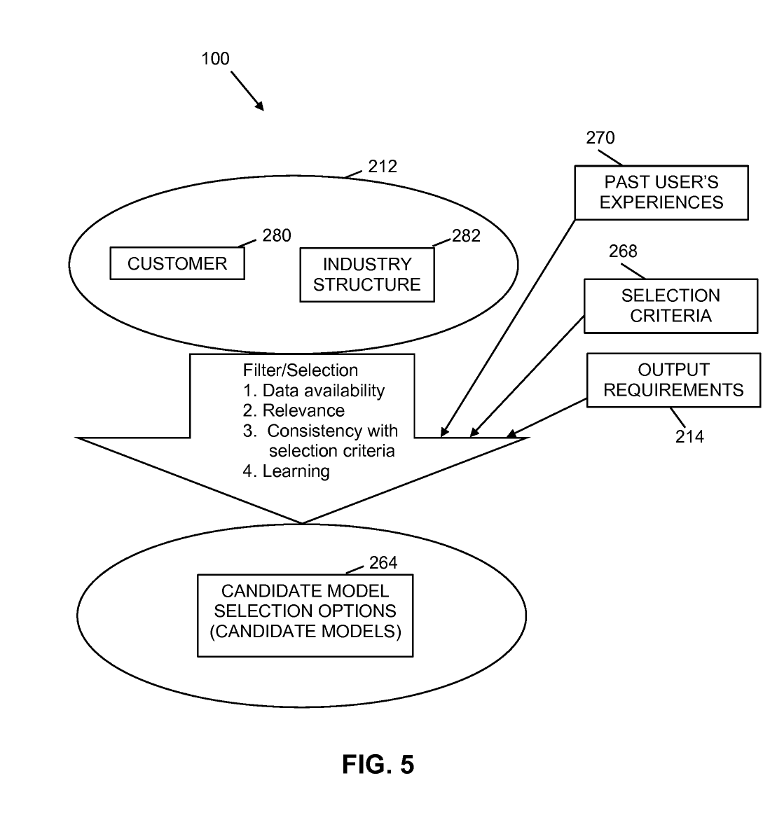

FIG. 5 illustrates the operation of the candidate model selection engine 110. Referring to FIGS. 3 and 5, once the transactional data 210, industry-specific data 212 and output requirements 214 are input via the input collection engine 100, the candidate model selection engine 110 uses the information collected to select a set of modeling options 264 that are determined to be applicable to the market structure and industry of the analysis.

Information usable to the candidate model selection engine 110 may include the industry-specific data 212, the output requirements 214 (that help to identify the final target of the analysis), and selection criteria (e.g., rules) 268 as to how to process information learned by the system through experience from past user experience 270. Industry-specific data 212 may be clustered in homogeneous groups/categories that the candidate model selection engine 110 uses to identify the market structure and industry type. These groups may be related to the structure of the industry 280 (e.g., degree of competition) and to characteristics of the customers 280 (e.g., demographic, income, degree of risk aversion, etc.). The groups are created by the user via the input collection engine 100 or by the candidate model selection engine 110 based on previous user experience.

The candidate model selection engine 110 selects one or more candidate model options 264 based on, for example, the industry-specific data 212, the output requirements 214, and a set of rules. The candidate model selection engine 110 examines a set of rules and checks the rules against the information presented—output requirements 214 and industry specific data 212. The rules may be stored in a library of rules and some rules may emerge from learning resulting from detecting that users' selections are correlated with specific industry data causing various automatic model selection rules to be created. The rules may specify, for example, how the industry-specific data 212 is to be used by the candidate model selection engine 110. For example, to estimate the price elasticity of the user's own brand A, the candidate model selection engine 110 determines from the industry-specific data 212 whether the market structure is a monopoly (e.g., a single brand), an oligopoly (a few brands), or perfect competition (many brands). The candidate model options 264 may be stored in pre-existing libraries that may be updated with additions or deletions by the user(s). The selection is such that the set of modeling options 264 identified (e.g., models of competition versus monopoly, stationary versus dynamic models, linear versus non-linear models, etc.) is supported by data availability, and it is consistent with the satisfaction of the output requirements.

Based on, for example, the industry-specific data 212, the output requirements 214, and the selection criteria (rules) 268, the candidate model selection engine 110 selects one or more models to include in the candidate model selection options 264 for further examination by the final model selection engine 120 (described below). Some implementations may include, as an input to the candidate model selection engine, the past user's experiences 270. Input 270 may include a default model resulting from a previous run of the system. For example, a particular model previously may have been determined by the final model selection engine 120 to be the model of choice for analyzing the data. That particular model may be specified to the candidate model selection engine 110 by the user. In some implementations, the final model selection engine 120 determines whether the specified default model is acceptable or not (as described below). If the default model remains acceptable, no other model options are tested by the final model selection engine 120. If, however, the default model is determined not to be acceptable by the final model selection engine 120, the user is so notified and control loops back to the candidate model selection engine 110 to identify one or more other candidate model selection options as explained above.

Final Model Selection

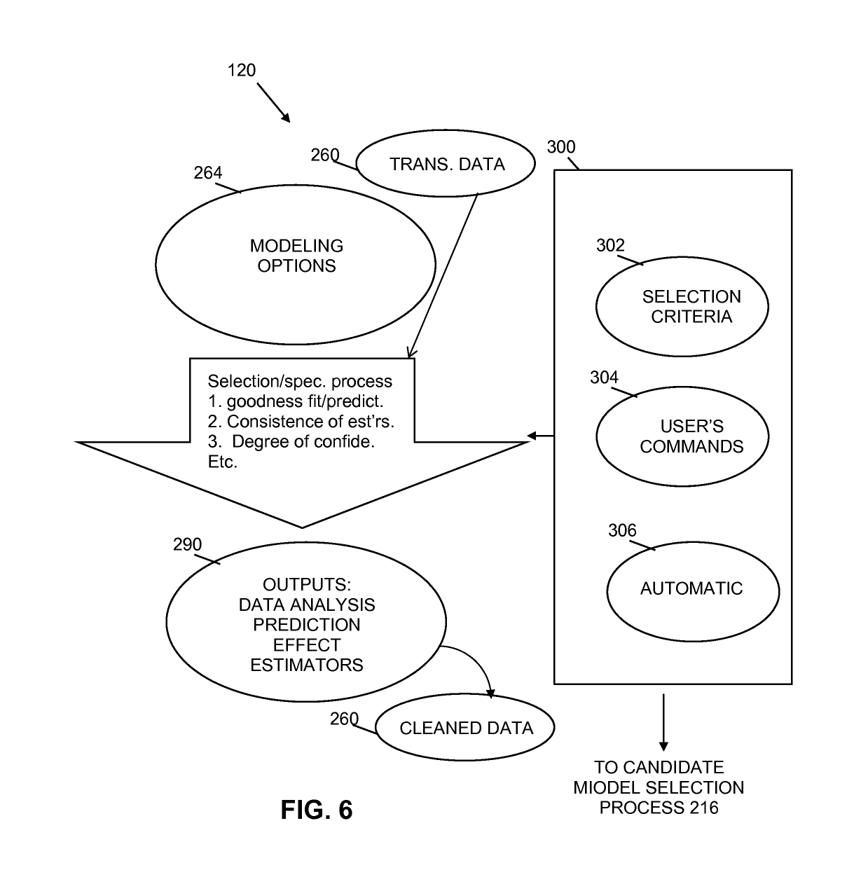

The operation performed by the final model selection engine 120 is illustrated in FIG. 6. Based on, for example, the transactional data 210, the final model selection engine 120 determines which of the possibly multiple candidate model selection options 264 performs best and selects the final model accordingly from the set of candidate models. The final model selection engine 120 determines the number of parameters that will need to be estimated based on the demand function formulation and the number of observation points there are in the data. From that, the final model selection engine 120 determines whether there are enough degrees of freedom to robustly and accurately estimate the model within the specification of the output requirements (e.g., with 95% confidence level). Further, the engine 120 examines the relationship among the variables for any known issues in the observed variables that would need to be accounted for in the model formulation. The final model selection engine 120 determines whether there is, for example, multi-colinearity—the input variables are correlated with each other (e.g., advertising levels of brand A and brand B being correlated with each other). It also checks for endogeneity of the variables (e.g., sales of brand A being a function of advertising levels of brand A and advertising levels of brand A being a function of sales of brand A from a previous period).

The candidate model selection options 264 are subject to a predetermined set of tests (e.g., colinearity test, endogeneity test, etc.) by the final model selection engine 120. The candidate model option(s) that do not pass the tests are dropped from further consideration. The results of these tests may be displayed to a user via output device 154 so that the user can see which candidate model options were rejected and which were accepted.

The final model selection engine 120 also “cleans” the transactional data 210 to produce cleaned data 260. Cleaning the transactional data 210 may include processing the data in accordance with data format requirements of the candidate models. Before, during or after a set of models is selected by the final model selection engine 120, the models may need the data to be presented in a certain format. For example, the transactional data 210 may need to be ordered by date, normalized (e.g., demeaned and scaled). The variables may be subtracted by their means and divided by the standard deviation. Certain attributes may need to be computed. The variables may need to be transformed to a logarithmic scale or quadratic values of the attributes may need to be computed for inclusion in the formulation. Further, any missing observations or outliers in the data may need to be accounted for. For example, the user may want to estimate the price elasticity of his own brand A. Further, the industry-specific data 212 on the market structure may indicate that the market comprises two brands A and B and the market share of brand B is large enough to influence the demand for brand A. In this example, the final model selection engine 120 determines that the demand function formulation should include not only the own price of brand A but also the competitive brand B's price as well. Further, the final model selection engine 120 determines that the transactional data supplied by the user does not include price data for brand B on different purchase visits. The ‘gap’ is the information on competitor's price for brand B as it is a known important variable in the demand function formulation for brand A for this type of market structure and for this type of outcome variable.

Given the set of candidate models 264 determined by the candidate model selection engine 110, the final candidate selection engine 120 verifies which candidate model performs better in terms of the output requirements 214 set by the user. Different test data and testing algorithms (e.g., stationary time series versus dynamic time series models) are employed by the final model selection engine 120 to test the candidate model options 264 with the results being compared. For example, the candidate models for demand estimation of brand A may be a linear model, a log-linear model, and a log-log model with various variables such as brand A sales being a function of price of brand A, advertising levels of brand A, price of brand B, advertising levels of brand B, brand A sales from previous period, brand B sales from previous period, etc. The final model selection engine 120 may estimate all three models using calibration data and compare various fit statistics in the calibration sample such as R-square, number of variables with the correct sign (positive or negative), log-likelihood function value, etc. The final model selection engine 120 also may assess the performance of the models by performing tests for the three models in holdout samples and compare model fit statistics in holdout samples such as Bayesian information criteria, Akaike information criteria, log-likelihood value, hit rate (e.g., number of times the actual value and estimated value are within the predefined confidence interval). Based on these tests for fits, the final model selection engine 120 may select the final model and present the analysis to the user. For example, the final model selection engine 120 may present to the user the estimated value of the price elasticity of the user's own brand A.

In the event that one candidate model option 264 does not perform better than another, multiple alternative models are provided to the input collection engine 100 and offered to the user via output device 154 for the user to make a final choice. In the case of an analysis that involves a dynamic inflow of data, the final model selection engine 120 verifies that the past modeling choices are still optimal and robust. That is, if a model has been generated and selected by a user, but additional transactional data 210, industry-specific data 214, and/or output requirements 214 are provided by the input collection engine 100, the processes described above with regard to engines 100, 110, and 120 are iterated to ensure that the currently determined model is the correct choice. If it is not, a different model is offered to the user.

In accordance with at least some implementations, the final model presented to the user is a model equation with the estimated values of the unknown parameters in the equation, as well as the estimates of the target outcome variable(s). Further, the final model selection engine 120 may perform the final selected model on the transactional data 210 to generate output processed data, which is then provided to a user via the output delivery engine (e.g., displaying, printing, etc.).

When the default model (selected in previous runs) underperforms in terms of some predetermined dimension, then the software automatically re-consider the choices made in earlier operations such as the candidate model selection process 216. For example, in the above example, the model may not complete the computation in less than 1 hour, or the confidence interval may be larger than what was requested. Control then loops back to the candidate model selection process 216 or the input collection engine 100 may request additional inputs from the user. A verification/test may be automatically performed (306) or user-induced via a user command 304 via input device 152. An example of a verification test is a test or series of tests to check whether the output requirements 214 are being met. For example, to check if the estimates of the price elasticity of brand A are robust (fall in the same range), the final model selection engine 120 may perform repeated executions of the model with the same calibration data and with other calibration samples and then compare the estimated values over the repeated executions. Whenever the user is aware of a structural change that may require re-evaluating the model selection, the user can force the system to start from the input collection process 200 again, taking in account the new information. The selection criteria 302 are determined by the type of analysis based on the output requirements 214. For example, if the user becomes aware that the market now has a new brand C that should be included in the demand formulation for brand A, the user can restart the model selection process. The selection of the candidate models will then include this new information about the market structure (including brand C) in deciding the set of models and use additional variables in the demand formula and estimate the price elasticity for brand A. The user may still want the same level of accuracy. The selection criteria 302 in FIG. 6 and the selection criteria in FIG. 5 may be the same or different from each other. For example, in the candidate model selection process 216, the selection criteria 268 may use the market structure or linear/non-linear relationship to select the candidate models, but in the final model selection process 218, the selection criteria 302 may use model fit statistics to select the final model.

The disclosed implementation is flexible and can be used in different market structure and industry situations, with different levels of data availability and for different business needs. Further, the system described herein is easy to use and will reduce the time and complexity of the process of developing a data analytical modeling solution. The system is transparent and allows the business user to interact with it and ensure it is correctly specified. It is dynamic and can learn from current user inputs, past inputs from the user as well as inputs by other users. The system can enable the use of data analytical models to be offered as a service offering in the cloud.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
an input collection engine to receive transactional data, industry-specific data, output requirements, and instructions to run specific data analysis models and tests;
a candidate model selection engine to identify, from a plurality of models and based on the industry-specific data and the output requirements, a set of candidate models;
a final model selection engine to use the instructions to assess the performance of each candidate model based on the transactional data, to select a final model from the set of candidate models, and to run the final model selected on the transactional data to generate processed data.

2. The system of claim 1 wherein said candidate model selection engine is to provide a default model to the final model selection engine, the default model resulting from a previous run of the system.

3. The system of claim 2 wherein the final model selection engine determines whether the default model is acceptable, and if the default model is not acceptable, a user is notified that the default model is not acceptable and the candidate model selection engine is to identify the set of candidate models also based on a set of rules that specify how the candidate model selection engine is to use the industry-specific data and the output requirements to identify the set of candidate models.

4. The system of claim 1 wherein the candidate model selection engine is to provide feedback to a user thereby identifying the set of candidate models.

5. The system of claim 1 wherein said candidate model selection engine is to identify the set of candidate models also based on a set of rules that specify how the candidate model selection engine is to use the industry-specific data and the output requirements to identify the set of candidate models.

6. The system of claim 1 wherein said final model selection engine is to process the transactional data in accordance with data format requirements of one or more identified candidate models, and wherein the final model selection engine is to assess the performance of each candidate model based on the processed transactional data.

7. The system of claim 1 wherein said input collection engine also is to identify rules for candidate model selection based on previously performed analyses.

8. The system of claim 1 wherein the final model selection engine is to assess the performance of each candidate model by determining model fit statistics.

9. The system of claim 1 wherein the final model selection engine determines, based on the industry-specific data, if data is missing from the transactional data and prompts the user for the missing transactional data.

10. The system of claim 1 further comprising an output delivery engine to provide the processed data generated by the final model selection engine.

11. A non-transitory, computer-readable storage medium containing software that, when executed by a processor, causes the processor to:
receive transactional data, industry-specific data, output requirements, and instructions to run specific data analysis models and tests, wherein the industry-specific data defines a market's structure;
identify, based on the industry-specific data and the output requirements, a set of candidate models;
use the instructions to assess the performance of each candidate model based on the transactional data to select a final model and to perform the selected final model on the transactional data to generate processed data; and
to provide the processed data to a user.

12. The non-transitory, computer-readable storage medium of claim 11 wherein the software causes the processor to provide a default model from a previous execution of the software.

13. The non-transitory, computer-readable storage medium of claim 12 wherein the software causes the processor to determine whether the default model is acceptable, and if the default model is not acceptable, a user is notified that the default model is not acceptable and the software causes the processor to identify the set of candidate models also based on a set of rules that specify how the industry-specific data and the output requirements are to be used to identify the set of candidate models.

14. The non-transitory, computer-readable storage medium of claim 11 wherein the software causes the processor to identify the set of candidate models also based on a set of rules that specify how the industry-specific data and the output requirements are to be used to identify the set of candidate models.

15. The non-transitory, computer-readable storage medium of claim 11 wherein the software also causes the processor to process the transactional data in accordance with data format requirements of one or more identified candidate models and to assess the performance of each candidate model based on the processed transactional data.

16. The non-transitory, computer-readable storage medium of claim 11 wherein the software also causes the processor to identify rules for candidate model selection based on previously performed analyses.

17. (canceled)

18. The non-transitory, computer-readable storage medium of claim 11 wherein the software also causes the processor to determine, based on the industry-specific data, whether data is missing from the transactional data and to prompt the user for the missing transactional data.

19. A method, comprising:
receiving, by a hardware processor, transactional data, industry-specific data, and output requirements, and instructions to run specific data analysis models and tests, wherein the industry-specific data defines a market's structure;
identifying, by the hardware processor and based on the industry-specific data and the output requirements, a set of candidate models and to provide feedback to a user thereby identifying the set of candidate models;
using, by the hardware processor, the instructions to assess the performance of each candidate model based on the transactional data to select a final model;
performing, by the hardware processor, the selected final model on the transactional data to generate processed data; and
providing the processed data to a user.

20. The method of claim 19 further comprising providing a default model as a candidate model, wherein performance of the default model having been previously assessed and further comprising determining whether the default model is acceptable, and if the default model is not acceptable, notifying a user that the default model is not acceptable and identifying the set of candidate models also based on a set of rules that specify how the industry-specific data and the output requirements are to be used to identify the set of candidate models.

21. The non-transitory, computer-readable storage medium of claim 11 wherein the industry-specific data includes at least one of market share, number of brands in the market, customer segmentation dimensions, and brand tiers.
